(19) United States
(12) Patent Application Publication
(10) Pub. No.: US 2019/0213604 A1
(43) Pub. Date: Jul. 11, 2019

(54) Validated Article of Commerce

(71) Applicant: The Procter & Gamble Company, Cincinnati, OH (US)

(72) Inventors: Grant Robert Meadows, Middlesex (GB); Jonathan Richard Stonehouse, Windlesham (GB)

(73) Assignee: The Procter & Gamble Company, Cincinnati, OH (US)

(21) Appl. No.: 14/179,576

(22) Filed: Feb. 13, 2014

(51) Int. Cl. G06Q 30/00

(52) U.S. Cl. CPC G06Q 30/0185

(57) ABSTRACT

An article of commerce comprises printed indicia including an alpha-numeric character string. A value associated with one or more characters of the string may be used to determine a location of a validity indicator disposed upon the article. A key to the appropriate location of the validity indicator may be provided.

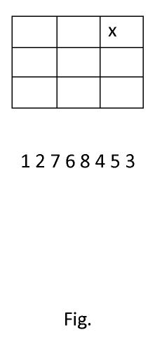

### FIELD OF THE INVENTION

The invention relates to articles of commerce amenable to validation and to methods for the validation of those articles. The invention relates particularly to validity indications via printed indicia and their methods of use.

### BACKGROUND OF THE INVENTION

Articles of commerce comprising printed indicia upon the article itself or upon packaging materials associated with the article are known in the art. Counterfeit versions of these articles having high fidelity to the appearance of the genuine articles are also well known. The availability of common packaging materials together with common packaging and printing process equipment yields an environment wherein counterfeiters may create nearly identical articles for introduction into the streams of commerce.

This environment creates the challenge of quickly and reliably differentiating genuine goods from counterfeit goods. Ideally, this differentiation would be possible through an examination of the packaging materials associated with the goods and would not necessitate actual testing or examination of the underlying goods themselves. What is needed is a form of the goods carrying an indicia of authenticity easily discernible but not easily duplicated by those seeking to counterfeit the goods.

### SUMMARY OF THE INVENTION

In one aspect the invention comprises an article of commerce or good. The good, in turn, comprises a series of alpha-numeric characters arrayed as a string upon a surface of the good or a surface of the packaging associated with the good. The good further comprises a validation indicator disposed upon a surface of the good or the associated packaging in registration with the alpha-numeric string in a location determined according to the value of a character within the string.

In one aspect the invention comprises a method for providing goods easily validated as authentic. The method comprising steps of: providing a good comprising an indicia including a unique alpha-numeric character string, disposing a validation indicator upon the good in a location determined according to the value of at least one character of the alpha-numeric string, providing a key for determining the valid location of the validation indicator according to the value of the alpha-numeric string of characters.

### BRIEF DESCRIPTION OF THE DRAWINGS

The FIGURE provides a schematic illustration of indicia according to one embodiment of the invention.

### DETAILED DESCRIPTION OF THE INVENTION

As used herein, the term “goods” refers broadly to articles of commerce together with the packaging materials associated with the articles. Goods may range from disposable consumer goods, to durable goods, to computer software, music, video files, or games, essentially any item which may be transferred in a physical form as part of a transaction.

As used herein, packaging materials refers to the primary, secondary, tertiary etc, levels of packaging materials associated with a particular good. Packaging materials include bottles, cans, boxes, together with labels, protective wrappings etc. associated with the primary packaging of a product.

At least one portion of the combination of the goods and associated packaging comprises printed indicia. The indicia may be printed using flexographic, lithographic, silk screen, inkjet, gravure or other printing process as are known in the art. The printing may be a single color or may comprise multiple colors of a palette associated with the indicia. The use of a color palette afford the dimensional separation of the respective colors according to their individual CIE L*a*b values in a defined color space. In such a space, the L value corresponds to the lightness of the individual colors and allows them to be sorted from lightest to darkest according to the ascending values of L.

For improved efficiency in the manufacturing of a large number of different products, each product requiring different packaging materials, manufacturers may distinguish each particular packaging material with the use of a unique part number printed upon the discrete materials. As an example, the primary package may have a number printed upon it as part of the primary package decoration printing, a beverage can may have a number unique to the particular flavor of beverage the can is intended to hold printed as part of the overall decoration of the can, the secondary package, the box into which a number of individual cans will be packaged, may have a second unique number associated with the flavor of the beverage as well as the number of cans. Carrying this out, cola cans may have a different number than diet cola cans, the number for a package of twelve cans of diet cola may differ from the number for either of the package for twelve cans of cola or twenty-four cans of diet cola. In this manner the complexities of manufacturing a wide array of different combinations of packaging materials may be efficiently dealt with and high level of quality may be achieved.

The existence of these unique part numbers affords the manufacturer opportunity to introduce a validation indicator for the purpose of enabling the rapid authentication of the goods by anyone in possession of the appropriate key to the validation indicator. This key may be provided to organizations and individuals along the overall chain from package material manufacturer to retailer and/or consumer for the purposes of creating the authentic packaging materials to actual authentication of the goods.

In practice, the indicia may comprise a part number of multiple alpha-numeric characters. As an example to be used herein, the part number is specified as having eight alpha-numeric characters arrayed as string of characters upon the packaging material. Each of the characters may be selected from a predefined set of characters such that any alphabet, set of numerals, or what may be referred to as special characters—those characters commonly available for use but outside the alphabet, may be included. Each character may be assigned a numeric value according to a predefined key of values. The defined value is provided as part of the key to enable a party attempting to determine the authenticity of the goods to determine if the validation indicator is present in the proper location to indicate authenticity.

Returning to the example of an eight character string, the value of one character in the string, for example, the last character, may be used to determine the proper location for the validity indicator associated with that particular string. A particular location for the validity indicator is predefined for each possible value of the character. For example, for a value of one, the validity indicator may be disposed at a location above the first character of the string, a value of two yields a predefined location above the second character, and so on. In this example, the values greater than the maximum number of characters in the string, i.e. 8, may indicate a wrapping of the location such that a value of nine indicates a disposition of the validity indicator once again above the first character, or alternatively, below the first character of the string as desired. Values may correspond to locations in any chosen manner and need not follow the exemplary prescription of the second location logically following the first. Locations may be chosen arbitrarily and captured in the key for purposes of disseminating the proper locations to appropriate individuals and entities. Locations may be chosen as a function of one or more character string values, as an example, the location may be specified as the value of the first character multiplied by the value of the last character with the product then cross referenced to a value—location table to determine the ultimate location of the validity indicator with respect to the character string. Similarly, the location may be determined according to the value of the last character of the string, or the nth character wherein n is determined as the value of the first, last, or other specified character, or function of the values of a single or multiple characters as chosen. In one embodiment, the validity indicator is considered to be disposed in registration with the character string. That is, the location of the validity indicator is relative to that of the respective characters of the string rather than to a particular location of the indicator upon the packaging material itself.

Alternatively, the location of the validity indicator may be defined in terms of a location upon the packaging material with little or no relationship to the location of the character string. As an example, illustrated in the FIGURE, a set of validity indicator locations may be prescribed as an array of locations upon the packaging materials, as shown in the FIGURE, a validity indicator “x” is disposed at location 3 of 9 in accordance with the value of the last character of the string. The validity indicator(s) could also be disposed at particular locations distributed across the entirety of the packaging material with the presence or absence of the indicator at any particular prescribed location dependent upon the particular defined values of the character string. In one example, a defined character value of one may prescribe the presence of a validity indicator at a location precisely one inch (2.54 mm) below and to the left of the upper left corner of the packaging material artwork, with defined character values other than one each prescribing a different respective location for the validity indicator. Facilitating this degree of flexibility in the translation of the character string values to the validity indicator locations requires only the use of an appropriate and sufficiently detailed location key.

The validity indicator may further be provided as an absence of printing at a location determined according to the characters of the string. In one example, the values may prescribe a particular location for the indicator upon the product artwork. Absent this determination, the determined location may have a particular printed color as part of the product artwork. In this example, the determination of the particular location as that of the validity indicia may result in nothing being printed at the location yielding an ink-free area within or upon the edge of an otherwise printed portion of the artwork.

In one example, the indicator may comprise an indicia associated with the goods, such as a product logo or the product name and the location of the logo or name may be defined according to the character string value(s).

Multi-color printing processes for the creation of advanced color graphic indicia provide an additional dimension for the validity indicator. Beyond single color printing processes, multi-color palettes may be available for the creation of the packaging artwork and the associated part numbers and validity indicators. In one embodiment, evaluation of the package artwork may yield the information that the part number will be printed upon a particular background color. The background color will have a color space value of L (lightness) associated with it, as will each color of the intended palette of colors for the artwork printing operation. The lightest palette color (having the lowest L value), darkest palette color (having the highest L value) or any of the colors of the palette other than the background color—if the background color is a part of the palette and not the color of the underlying printing substrate—may be utilized as the intended color of the validity indicator.

The methodology of the invention may be utilized with a more complex array of processes beyond printing. In one embodiment, the value(s) of the character string may determine a particular location for the validity indicator. The actual indicator may then be formed using a secondary process other than the printing of the artwork, such as a laser, to burn away a portion of the printed artwork, or other aspect of the packaging materials at the determined location. Again, an appropriately detailed authenticity key would enable the determination of the authentic signature for the given product.

The key may be disseminated in a physical form, either printed or via an electronic media, compact disc, digital video disc, flash memory, or other electronic media, or may be may available via a controlled user access over a network such as by validated user access to the key via the internet.

An interested user may then examine the goods, evaluate the value of the character strings, the location of the validity indicator and upon consultation with the key, determine if the validity indicator is authentically located upon the goods. In consulting the key, the user may be required to identify themselves or to otherwise secure access to the appropriate key, then identify the goods in question and then to extract from the key the requisite information relating to the appropriate validity indicator(s) for those goods.

The system may be as simple as a single validity indicator or the use of multiple indicators across a single element of packaging material or across multiple packaging materials associated with the particular goods.

The key may be provided to the manufacturer of the packaging materials as a guide to the preparation of the printing process for the materials. In one example, the key may indicate that the validity indicator should be disposed above the first character of the string and should comprise as small a printed dot as the process allows. Depending upon the respective printing process being utilized, this information may lead to the appropriate preparation of the associated physical printing plates, or associated electronic files to include the necessary structures and/or information for the creation of the validity indicator upon the packaging materials. As an example, the desired location may be above the first character leading to the creation of a flexographic plate having a structure which will yield a dot at that location when in use.

The articles and methods of validation of the invention may incorporate the use of a barcode, such as a Universal Product Code, printed upon the packaging or the article itself. In one embodiment, one or more of the characters of the numeric string associated with the UPC may be used as described above to determine a value upon which validation will be based. As an example, the final character of the barcode may be used as the basis for locating one or more validation aspects upon the barcode. For a character value of n, the nth character of the string may be expressed in a font varying from that of the remaining characters of the string. Similarly, the bars associated with the nth character may be altered in a prescribed manner to enable their deviation from the standard form to serve as a validation marker. In addition to these forms or as an alternative to them, a validity indicator may be printed in proximity to the nth character of the string utilizing one of the colors of the printing ink palette associated with the artwork. These features may be used individually or in combinations to provide indications of validity.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A printed article of manufacture comprising printed indicia, the indicia comprising:
a) a series of alpha-numeric characters arrayed as a string of characters, wherein the series of alpha-numeric characters are printed on the printed article of manufacture;
b) a graphic;
c) at least one validation indicator disposed on the printed article of manufacture, wherein the validation indicator is an ink-free area within the graphic; and
wherein the location of the validation indicator is determined according to an assigned value of one of the alpha-numeric characters.

2. The printed article according to claim 1 wherein the location of the validation indicator is determined according to the assigned value of a first alpha-numeric character.

3. The printed article according to claim 1 wherein the location of the validation indicator is determined according to the assigned value of a last alpha-numeric character.

4. The printed article according to claim 1 wherein the location of the validation indicator is determined according to the assigned value of an nth alpha-numeric character, wherein n is the assigned value of a first alpha-numeric character.

5. The printed article according to claim 1 wherein the location of the validation indicator is determined according to the assigned value of the nth alpha-numeric character, wherein n is the assigned value of the last alpha-numeric character.

6. The printed article according to claim 1 wherein the location of the validation indicator is determined according to a function of the assigned value of at least one character of the alpha-numeric string.

7. (canceled)

8. (canceled)

9. The printed article according to claim 1 wherein the series of alpha-numeric characters comprises a part number associated with a particular package material item.

10. A method for providing an indication of authenticity of goods, the method comprising steps of:
a) providing a good comprising an indicia including a unique alpha-numeric character string and a graphic printed on the good;
b) providing a validation indicator on the good that consists of an ink-free area within the graphic, wherein the location of the validation indicator is determined according to an assigned value of at least one character of the alpha-numeric string.

11. The method according to claim 10 further comprising the step of determining the location of the validation indicator according to the assigned value of a first alpha-numeric character.

12. The method according to claim 10 further comprising the step of determining the location of the validation indicator according to the assigned value of a last alpha-numeric character.

13. The method according to claim 10 further comprising the step of determining the location of the validation indicator according to the assigned value of the nth alpha-numeric character, wherein n is the assigned value of the first alpha-numeric character.

14. The method according to claim 10 further comprising the step of determining the location of the validation indicator according to the assigned value of an nth alpha-numeric character, wherein n is the assigned value of a last alpha-numeric character.

15. The method according to claim 10 further comprising the step of determining the location of the validation indicator according to a function of the predetermined value of at least one character of the alpha-numeric string.

16. (canceled)

17. (canceled)

18. The method according to claim 10 further comprising the step of selecting as the series of alpha-numeric characters a part number associated with a particular package material item.

19. The method according to claim 10 further comprising the step of providing a key as to the authentic location of the validity indicator.
